(19) United States
(12) Patent Application Publication
(10) Pub. No.: US 2009/0248452 A1
(43) Pub. Date: Oct. 1, 2009

(54) Method and Apparatus for Controlling Insurance Business Processes

(75) Inventors: Matthew Carl Hamilton, Pacifica, CA (US); Christopher James Campo, Cupertino, CA (US)

Correspondence Address: FITCH EVEN TABIN & FLANNERY, 120 SOUTH LASALLE STREET, SUITE 1600, CHICAGO, IL, 60603-3406, US

(73) Assignee: GUIDEWIRE SOFTWARE, INC., San Mateo, CA (US)

(21) Appl. No.: 12/056,846

(22) Filed: Mar. 27, 2008

(51) Int. Cl. G06Q 40/00

(52) U.S. Cl. 705/4

(57) ABSTRACT

A computer-based insurance billing system for use in controlling insurance business processes is provided. As used herein the insurance business processes may include delinquency, invoicing, accruing earned commissions, paying commissions, distributing received payments, and disbursing owed amount, to note a few. At a user interface, the end user is provided (101) an opportunity to effect a trouble ticked with respect to a particular insurance entity. The characteristics of the trouble ticket may be automatically determined (102) to identify which of the insurance business processes relate to the trouble ticket. The end user is automatically provided (103) an opportunity to establish a temporary hold on the identified insurance business processes.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates generally to the computer-based management of insurance billing and related processes.

### BACKGROUND

Insurance policies are known in the art and typically comprise complex agreements that specify items to be afforded coverage with respect to particular perils. Numerous conditions typically apply including applicable deductibles, coverage limits, and so forth. Important policy information also includes details of the particular covered risk, the payment or premium amounts, the policy period, and the effective date, among others. Insurance carriers manage numerous policies and many insurance business processes such as claim handling and policy billing. By one approach, the billing process encompasses an array of accounting processes including invoicing; payment tracking; delinquency proceedings; commission processing, tracking, and payments; cancellation or policy closure; and disbursements, to note but a few.

Automated computer-based processing systems assist with the management of the insurance policies, related information, and processes. Many of these systems serve to provide policy sales support, claim processing, information management, and/or billing management. Further, computer-based insurance billing systems are used to handle the billing and accounting processes related to the insurance policies in a centralized and automatic manner.

Notwithstanding significant advances provided by computer-based insurance billing systems, some issues yet remain. The automatic processing of a variety of billing-related processes allows for efficient and effective management of numerous policies when operating within the ordinary course of business, however, developments or circumstances outside of such a course may warrant deviation from the automatic process. In response to extenuating circumstances that would warrant a departure from the automatic process or the ordinary course of business, it may be desirable to halt progression of the automatic process, condition further action, or otherwise change the automatic process. Due to the structure, configuration, and organization of the systems in which the automatic processes occur, however, changes to the automatic processes often are difficult to accomplish and/or have unanticipated consequences.

Numerous circumstances may require deviation from the automatic processes. For example, if a policyholder reports a billing error, such as a statement including an incorrect amount, the insurance company may want to ensure that delinquency proceedings for non-payment do not begin (or if started, do not proceed) until the issue is resolved. Under some circumstances, an exception condition may arise that would require several automated processes to be temporarily held. For example, an incorrect application of funds in an account having multiple policies associated therewith might require that delinquency proceedings be held on all related policies, as well as holding commission payments to the agent in charge of the account. Automatically determining the relevant processes to hold, particularly when there is a complex relationship between the circumstances outside of the ordinary course of business and the automatic processes is challenging. Moreover, a change to a particular automatic process relating to one policy can inappropriately halt or otherwise disrupt other processes relating to the same policy. Additionally, such process alternations may interfere with processing as pertains to other related (or even unrelated) policies. In certain circumstances, altering an automatic process in the system could affect all of the policies affected by that particular automatic process. In addition to minor changes from the automatic processes creating other undesirable changes, altering the automatic process may be cumbersome or otherwise difficult to quickly and easily effect. For example, if an automatic process such as a billing process like invoicing needs to be temporary halted for all policy holders in a disaster-struck area, the system may require that each policy be individually accessed and flagged to effect the desired change to the standard automatic process. This, of course, can be cumbersome, error prone, and time consuming to accomplish. In addition, if the process to be altered is repetitive, the policy or account may have to be frequently monitored or the process hold repeatedly initiated.

### BRIEF DESCRIPTION OF THE DRAWINGS

The above needs are at least partially met through provision of the Method and Apparatus for Controlling Insurance Business Processes described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a flow diagram as configured in accordance with various embodiments of the invention;

FIG. 4 comprises a flow diagram as configured in accordance with various embodiments of the invention;

FIG. 5 comprises a block diagram as configured in accordance with various embodiments of the invention; and

FIG. 6 comprises an illustrative screen shot as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a computer-based insurance billing system for use in controlling insurance business processes enables the end user to effect a temporary hold on identified insurance business processes. At a user interface, the end user is provided an opportunity to effect a trouble ticket with respect to one or more insurance entities, wherein an insurance entity may include a policy, an account, an insurance producer such as a broker or an agent, and an insured individual, company, business, or property. Upon effecting the trouble ticket, the end user is automatically provided an opportunity to establish a temporary hold on insurance business processes managed by the billing system, as related to the insurance entities associated with the trouble ticket. For the insurance business processes selected to be temporarily held, the hold will be automatically apply with respect to the appropriate insurance entities that the user has selected or that were determined by the insurance billing system.

As mentioned, a trouble ticket may be effected with respect to one or a plurality of insurance entities. For example, if a payment was incorrectly applied to account B instead of account A, a single trouble ticket may be effected with respect to both insurance entities (account A and account B) such that a delinquency for account A will not commence or continue and a disbursement for account B will not issue.

Since the trouble ticket may be effected with respect to a plurality of insurance entities, selecting the insurance business processes to hold may further include the step of specifying which of the insurance entities associated with the trouble ticket should be affected by the hold. For example, if there are three policies associated with the trouble ticket, it may be desirable to hold policy cancellation for only one of the three policies. By default, the hold on cancellation may apply to all policies associated with the trouble ticket. However, the user may specify that the hold applies only to a subset of the associated entities. Thus, the insurance billing system may provide the end user an opportunity to manage the trouble ticket and the temporary holds such as by applying the temporary hold to all or a portion of the plurality of insurance entities. In addition, providing the end user the opportunity to manage the trouble ticket may further comprise the option to dynamically add or remove insurance entities associated with the trouble ticket and establish or remove the temporary holds applied to insurance business processes.

The insurance entity or entities may be associated with the trouble ticket in a variety of ways. The insurance entity may be directly identified such that the end user is provided an opportunity to specify the particular insurance entity. Alternatively, the insurance entity may be indirectly identified. By one approach, the end user may select conditions or characterizing properties, such as particular covered occurrences, such that the computer-based insurance billing system may generate the insurance entity or entities from that information. For example, the ends user may select all accounts that are billed in a particular postal code. By another approach, indirectly identifying the insurance entity might comprise providing the end user with an opportunity to identify the particular insurance entity by identifying a relationship with another specified entity. For example, the insurance entity may be associated with the trouble ticket by determining which insurance entities, such as policies and accounts, are associated with a producer, such as a particular insurance broker. In addition to these examples, there are numerous way that the insurance entities may be associated with trouble tickets. Further, such association may occur manually or automatically. Thus, the appropriate insurance entity or entities may be determined by the insurance billing system that may employ a number of criteria, rules, or logic, among other methods.

Automatically providing the end user with the opportunity to establish a temporary hold may include offering the end user a variety of temporary hold options. The temporary holds for which the end user is automatically provided an opportunity to establish may conclude within different time frames. By one approach, the opportunity provided is the opportunity to establish a temporary hold that will automatically expire on a specified date. By another approach, the temporary hold that may be established will automatically expire upon the conclusion of a specified interval of time. In another example, the computer-based insurance billing system provides the opportunity to establish a hold that will automatically expire when the trouble ticket is resolved.

As used herein the expression insurance business processes will be understood to potentially include delinquency processing, invoicing or the sending of statements, accruing earned commissions or commission processing, tracking commissions, paying commissions, payment tracking, distributing received payments, disbursing amounts owed, and cancellation or policy closure, to note but a few.

The opportunity to establish a temporary hold on the insurance processes may be provided at a variety of time frames. For example, the opportunity to establish the temporary hold may occur before the insurance business process has become active or may occur after the insurance business process is active.

Whatever type of temporary hold and however the insurance entities are determined, the temporary hold may be implemented or executed in a number of different ways such as in a workflow or hard coded. In one illustrative example, the business process is driven by a workflow and the entire workflow or certain workflow steps may be halted while the temporary hold is in effect. Alternatively, if the temporary hold is with respect to a specific transaction, such as a financial transaction, the logic executing the transaction may check to determine whether a temporary hold exists before continuing.

So configured, these teachings support providing the end user with an opportunity to establish a temporary hold on various insurance business processes. Such temporary holds may be created manually or by the system to represent an exception condition or problem. As a result, the system acquires some flexibility such that deviation from the ordinary course of business or the standard insurance business process may be efficiently, economically, and effectively generated for a single policy or for a group of selected policies. Those skilled in the art will recognize and appreciate that these teachings are suitable for use with a number of existing automated processes in this regard and also that these teachings are highly scalable and hence usable in a number of application settings employing from a very few to a very large number of business processes.

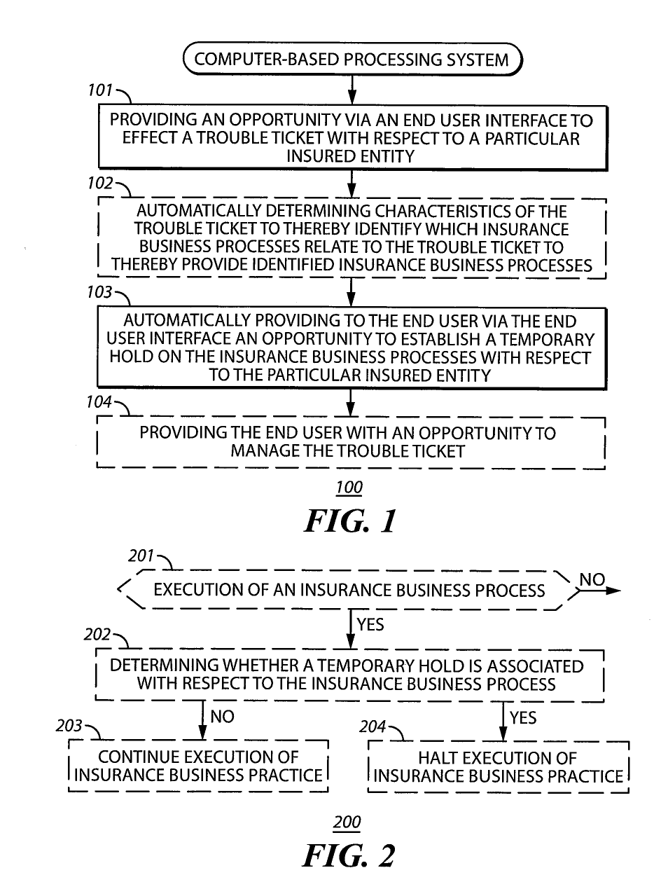

These and other benefits may become clearer upon making a thorough review and study of the following detailed description. Referring now to the drawings, and in particular to FIG. 1, an illustrative process that is compatible with many of these teachings will now be presented. An illustrative enabling method 100 will provide 101 an opportunity for an end user to effect a trouble ticket in a computer-based insurance billing system. The end user effects the trouble ticket with respect to a particular insurance entity wherein such a particular insurance entity may include one or a plurality of particular insurance entities.

Trouble tickets (virtual and actual) are generally known in the art. As used herein, a trouble ticket, which may be created manually by the end user or automatically by the system, is an instrument that serves to provide notice that some platform (which may be, for example, an executable software program and/or its implementing hardware) needs attention out of the ordinary course. Further, the trouble ticket may be employed as a way to manage exceptions to the ordinary course of business, including the automated insurance business processes. In addition, the trouble tickets also may be employed to assist with other business processes or track account history, to note but a few additional uses. For example, activities, notes, transactions, and an activity log may be associated with a trouble ticket.

By one approach, the end user may manually effect a trouble ticket when the end user is provided an opportunity to set up a trouble ticket in an insurance billing system, which then automatically provides the end user the opportunity to establish a temporary hold on the identified insurance business processes. Further, the insurance billing system may be configured and arranged to automatically determine the characteristics of the trouble ticket to identify relevant insurance business processes as discussed below.

By another approach, the system may be configured to automatically effect a trouble ticket without end-user initiation or other interaction with the system. For example, upon receipt of a notice from the bank of a bounced check the insurance billing system may automatically determine the characteristics of the notice, i.e. insufficient funds for payment, and then automatically create a trouble ticket associated with the relevant insurance entity and further apply a hold. The billing system may also expose a public application programming interface (API) to allow other systems to explicitly effect trouble tickets in the billing system. For example, an email to a system administrator may be automatically parsed by the computer-based insurance billing system to automatically effect a trouble ticket.

As shown in FIG. 1, the characteristics of the trouble ticket may be automatically determined 102 to thereby identify which insurance business processes are related to the trouble ticket. The identified insurance business processes may then be altered or temporarily held. To accomplish this, the end user is automatically provided 103 an opportunity to establish a temporary hold on the identified insurance business processes with respect to the particular insurance entity. For example, upon the creation of a trouble ticket with respect to a particular entity, the insurance billing system may search the insurance business processes to determine which of the insurance business processes relate to the trouble ticket and display a list of the relevant insurance business processes from which the end user may select to establish the temporary hold.

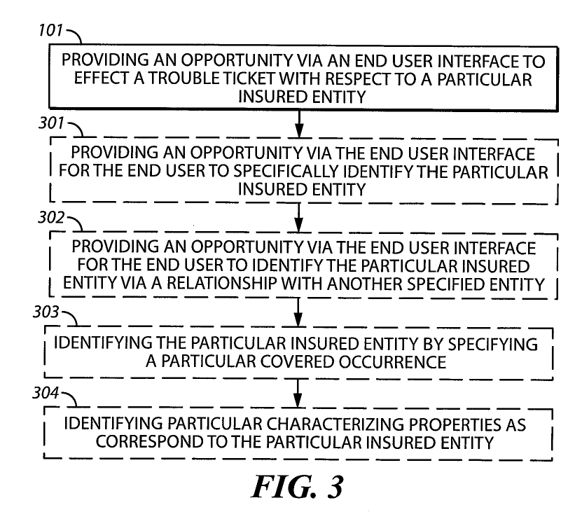

Referring now to FIG. 3, providing 101 an opportunity to effect a trouble ticket with respect to a particular insurance entity may occur in a plurality of manners. For example, the end user may be provided 301 an opportunity to specifically identify the particular insurance entity (by, for example, entering or selecting their name, their unique system identifier, and so forth). Further, the end user may directly identify the insurance entity in the insurance billing system such as, for example, by selecting a trouble ticket button displayed within a particular insurance entity, such as an account, or by inserting a particular insurance entity's information into a trouble ticket prompt, to note but a few options.

By another approach, a trouble ticket may be effected by providing 302 the end user an opportunity to identify the particular insurance entity indirectly, such as by the insurance entity's relationship with another specified entity. A particular insurance entity may be identified by its relationship to another specific entity wherein the another specified entity may be a policy sales agent, claims adjuster, or group affiliation, to note but a few. The another specified entity may have an insurance business process role with respect to the particular insurance entity. For example, since insurance carriers often view such policies as being products for which agents or other individuals receive credit or commissions for selling, it may be desirable to identify the policies for which an agent receives commissions so that a temporary hold may be established on those commissions. These and other trouble tickets may be created via a system prompt, a set-up wizard, or other method as desired.

In another illustrative approach, the insurance entity is identified 303 by specifying a covered occurrence. For example, the particular insured entities may be identified based on whether the insurance entity, such as a policy, includes coverage for an occurrence such as a hurricane, tornado, fire, earthquake, or other event. By yet another approach, the particular insurance entity is identified 304 by characterizing properties as correspond to the particular insurance entity. For example, the end user may identify characterizing properties such as the postal code of the covered property or residence of the policy holder, the age or age range of the policy holder, and deductible amounts, to note but a few characterizing properties.

Depending on the circumstances, it is contemplated that the trouble ticket may be effected with respect to a particular insurance entity that is identified based on a plurality of identifying criteria. For example, it may be desirable to identify insured entities that have a relationship with another specified entity and that also have particular characterizing properties. To illustrate by way of example, the particular insurance entities of interest may be policies issued by a particular sales agents in a certain postal code.

It is also contemplated, that trouble tickets may be preconfigured or previously defined to create trouble ticket types, wherein a particular type of trouble ticket may be preconfigured to identify insurance entities and establish particular temporary holds. The preconfigured or previously defined trouble tickets may have templates associated therewith such that the template can be employed when addressing a recurring trouble ticket type. For example, a common situation involves a policyholder that complains about an incorrect billing amount. To address such a recurring circumstance, a trouble ticket template may be preconfigured such that when a billing complaint arises, the trouble ticket template for a billing error may be selected wherein the template, by default, relates the trouble ticket to the policyholder's account. The template may also by default implement certain temporary holds. Such temporary holds may include, for example, a temporary hold on delinquency proceedings, among others. In addition, such a trouble ticket template for a billing error may also include logic to determine all associated policies and implement a temporary hold on policy cancellation, among others.

As mentioned above, the particular insurance entity may be a plurality of particular insurance entities. When providing 101 an opportunity to effect a trouble ticket with respect to particular insurance entities, the insurance entities may include a plurality of policies, accounts, insurance producers, and insured entities. In addition, a trouble ticket may be effected for a plurality of different types of insurance entities such that a trouble ticket may relate to a policy, an account, an insurance producer, and an insured entity.

As mentioned, the trouble ticket, whether applied to a particular insurance entity or a plurality of insurance entities, may be created in a plurality of manners. In addition, the end user may have the option to dynamically add or remove the insurance entities associated with the trouble ticket. For example, if a disaster-struck area comprises a portion of a postal code, the end user may desire to place a temporary hold on a number of business processes on all policies and/or accounts associated with individuals residing within the postal code. Once the individuals actually affected have been ascertained or the end user has confirmed that particular policy holders were not affect, the policies and/or accounts may be removed from the trouble ticket and the associated temporary holds. As suggested, such trouble tickets may be created manually through a prompt or selection or may be created automatically such as by logic rules or an API.

Returning momentarily to FIG. 1, the end user may also be provided 104 an opportunity to manage the trouble ticket. By managing the trouble tickets, the user may change the trouble tickets' temporary holds, parameters, or associations, to note but a few options. In addition, the trouble tickets may be employed to assist with other business processes or track account history through such management functionality. Further, the trouble tickets may be used to track activities, notes, transactions, and keep an activity log, among others.

The process 100, by one approach, automatically determines 102 characteristics of the trouble ticket to identify which insurance business processes relate to the trouble ticket. For example, if the particular insurance entities have been affected by a disaster such as a hurricane, the characteristics of the trouble ticket may relate to the invoicing, delinquency proceedings, or cancellation of a policy, among others, which may require alteration or exception from the ordinary course of business. In another illustrative example, if the trouble ticket is characterized as a non-payment of policy premiums the paying of commissions or other financially-related insurance business processes will typically relate to the trouble ticket. Thus, the characteristics of the trouble ticket may be automatically determined 102 to identify the insurance business processes which may require exception or alteration from the ordinary course of business such that the end user may be provided 103 an opportunity to establish a temporary hold on those insurance business processes that do, in fact, require alteration from the ordinary course of business. By one approach, upon examining the trouble ticket, the insurance billing system will display the identified insurance business processes that relate to the insurance entities associated. The display may be in the form of a list such that the user may select one or more of the identified insurance business processes on which to establish a temporary hold.

FIG. 2 depicts process 200 illustrating the implementation of the temporary hold during execution 201 of one of the insurance business processes. In one example, execution 201 occurs after creation of the trouble ticket and the temporary hold. The insurance billing system may be configured to execute the insurance business process in a variety of manners. Upon execution 201 of the insurance business process, the process 200 may be configured to determine 202 whether a temporary hold is associated with the insurance business process undergoing execution. If the process 200 determines that there is no temporary hold associated with insurance business process the execution continues 203. However, if it is determined that a temporary hold is associated with the insurance business process, the process 200 halts 204 the execution 201 of the insurance business process.

As previously mentioned, the insurance billing system may be configured to execute 201 the insurance business processes in a variety of manners. The computer-based insurance billing system may provide for a workflow engine to execute the insurance business processes. Further, the workflow may be configured and arranged in a pull model or push model. The computer-based insurance billing system also may be configured and arranged such that some or all of the insurance business processes are embedded in code such that they are implemented when the code is executed. A variety of methods may be used to execute the insurance business processes and implement associated temporary holds. The chosen methods may depend on the particular business process being executed and its configuration.

For example, upon execution of a certain insurance business process, the insurance billing system may search for trouble tickets associated with the insurance entities and determine whether that insurance business process has a temporary hold on it. If the insurance business process is temporarily held, then the insurance business process will not advance, otherwise, the insurance business process continues.

More particularly, by one approach, a relational database is employed, wherein a running or active insurance business process is represented by a database row with a foreign key relationship to an applicable insurance entity. The trouble ticket, in turn, has a foreign key relationship to one or more insurance entities. Such data-base level relationships allow the insurance business process to determine whether a temporary hold exists. The insurance business process may be configured to query the database to determine if the applicable insurance entity is associated with a trouble ticket and, if so, to retrieve the trouble tickets and determine if any of them specify a hold on the business process. This test may be done at various points in the business process to enable the temporary hold to stop the process as appropriate. For example, before the mailing of billing statements, the billing statement insurance business process may query the database to determine if applicable insurance entities that are to receive statements have any trouble tickets associated therewith. If the query does identify trouble tickets, the trouble tickets are examined to determine whether or not the trouble ticket requires a temporary hold on the billing statement or invoicing process.

In one illustrative example, delinquency processing, like other insurance business processing, is implemented using a workflow engine. Delinquency processing is typically associated with an account, wherein the delinquency process involves retrieving the account, querying to find any associated trouble tickets, examining the trouble tickets to see if there is a hold on the delinquency process, and stopping the workflow in if a temporary hold is active. Such a check or query for associated trouble tickets may be performed at multiple steps in the workflow, which would enable a newly established temporary hold to stop a workflow that has proceeded past the initial check. In some applications, it may be prudent to check for newly established temporary holds prior to each step in the workflow process. Configuring a workflow in this manner, along with using database queries to manage the insurance business processes, insurance entities, and trouble ticket will be familiar to those in the art and for the sake of brevity will not be outlined in more detail herein.

By another approach, insurance business processes, such as simpler business processes may be implemented directly in code. For example, disbursement involves initiating a payment. In such a case, the insurance business process may first determine the insurance entity to receive the disbursement and then query or check for trouble tickets associated with the insurance entity. Upon detection of a trouble ticket, the insurance business process determines whether a temporary hold exists with respect to the particular disbursement processes, and if so, stops the process or does not allow the process to continue processing the disbursement.

Thus, a variety of methods may be employed to implement a temporary hold after the creation of a trouble ticket and associated temporary holds. The effect of the temporary hold in the trouble ticket may differ depending on the specific process being held. For example, as mentioned, delinquency processing may be a workflow-based process. Therefore, the temporary hold may function to prevent the workflow from advancing. In other methods, the temporary hold may be implemented as a query or verification to confirm whether there is a temporary hold before the process continues. Such a check may be employed on a variety of insurance business processes such as disbursements or distributions, to note but a few.

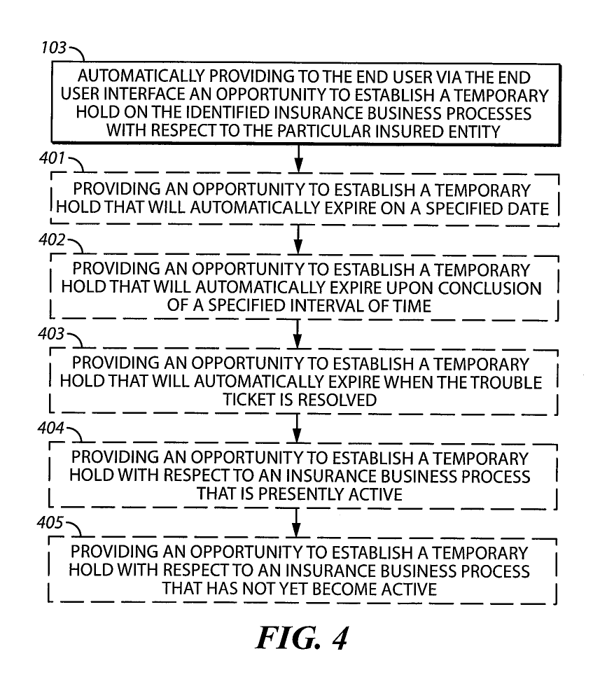

Turning now to FIG. 4, automatically providing 103 an opportunity to establish a temporary hold on the identified insurance business processes may include providing temporary holds having functionally different characteristics. By one approach, the temporarily holds conclude at different time frames. The end user may be provided 401 with an opportunity to establish a temporary hold that will automatically expire on a specified date. For example, if a temporary hold on delinquency proceedings is initiated, after a specified date, such as the first day of April, the temporary hold will expire and the delinquency proceedings will begin unless an intervening action occurs between the establishment of the hold and the specified date.

In one illustrative approach, the end user may also be provided 402 with an opportunity to establish a temporary hold that will automatically expire upon the conclusion of a specified interval of time. For example, a temporary hold on delinquency proceedings may be established such that the proceedings are stopped for thirty days and such that after the specified thirty days, delinquency proceedings will begin unless an intervening action occurs.

As mentioned, in one example, a workflow engine may implement the delinquency process. To implement a temporary hold that automatically expires upon the conclusion of a specified interval of time, the workflow may be configured such that upon encountering a temporary hold in the insurance business process the temporary hold is examined to determine the specific duration, if present. Upon determination of the specific duration, the workflow may be modified such that a holding workflow step is entered, wherein the holding workflow step automatically expires after the specific duration, thereby resuming the workflow at the step where the insurance business process was previously stopped. Such a configuration of the workflow engine provides for such a pause in the workflow and will be familiar to those skilled in the art and requires no further elaboration here.

By yet another approach, the end user may be provided 403 an opportunity to establish a temporary hold that will expire when the trouble ticket is resolved. Thus, the temporary hold may be in force until further action. For example, if a disaster has affected an area such that the invoicing for particular insurance entities is temporarily stopped, the hold will remain until the trouble ticket is resolved such that even if the standard procedure issues statements every thirty days, no statements will be sent until after the resolution of the trouble ticket.

As with a temporary hold that automatically expires, a temporary hold that expires upon the resolution of the trouble ticket may be implemented using a workflow engine configured to check periodically, at the temporary hold step, to determine if the temporary hold has expired. A workflow step may be configured such that the process attempts to continue or advance at a periodic interval. Such a workflow step may be conditional upon a specific event.

As mentioned, a relational database may be employed to help manage the insurance business processes, trouble tickets, and temporary holds. In such a case, the trouble ticket may include a status field thereby indicating whether the trouble ticket is active (open) or is resolved (closed). The workflow engine may periodically query or check for trouble tickets associated with insurance entities applicable to the process. Thus, if the trouble ticket(s) creating the temporary hold that was applied to the insurance business process is now resolved, the workflow may then resume and return to the step to which the temporary hold was applied.

In yet another example wherein the insurance business process is implemented directly in code, a regularly scheduled batch job, such as invoicing, may be configured to periodically attempt to execute the process. On each such attempt, the trouble tickets applicable to the insurance entity associated with the process may be found as previously described and examined to determine whether a temporary hold exists. If a hold applies, the batch job skips the attempt to execute the insurance business process for the insurance entity. When the temporary hold expires or the trouble ticket is resolved such that the temporary hold on the process is no longer active, a subsequent run of the batch job will not find active holds when attempting to execute the insurance business process. Thus, at that time, the attempt to execute will succeed. For example, in a disbursement process, a batch job may be configured to run nightly, such that the database is queried to find all pending disbursements and attempt to execute each such disbursement found. One of ordinary skill in the art will be familiar with configuring such a batch process and, for the sake of brevity further elaboration will not be provided here.

As used herein, a temporary hold includes a temporal cessation thereby temporarily stopping one of the plurality of business process. The hold and the associated trouble ticket have relevant timeframes associated therewith. The generally temporal nature of the hold anticipates that the event or other preceding circumstance may be resolved such that the business process will be resumed. Once the hold is deactivated, expires, or is closed the insurance business process will continue in ordinary course.

A number of outcomes may result when the trouble ticket is resolved: the insurance business process may continue normally such that invoicing and other processes continue; certain business processes like delinquency proceedings may begin, continue, or terminate, depending on the outcome of the trouble ticket; and in other situations, the temporary hold could become permanent. In one illustrative example, if a policy holder notifies the insurance company that she has been billed for an incorrect amount and that she is not going to pay the incorrect amount, the insurance agent may effect a trouble ticket and establish a temporary hold on the commencement of delinquency proceedings. Resolution of the trouble ticket will release the temporary hold and a variety of outcomes may occur upon release of the temporary hold.

Upon resolution of the trouble ticket, the computer-based insurance billing system may be configured to notify the policy holder about the resolution of the trouble ticket and release of the temporary hold. Such notification may include information regarding what will occur now that the trouble ticket has been resolved. As mentioned, depending on how the trouble ticket is resolved, a number of results could occur. For example, resolution of the trouble ticket may occur if the policy holder that complained about the incorrect billing amount is correct. Thus, upon resolution of the trouble ticket and release of the temporary hold, the insurance business process will not commence the delinquency proceedings. However, if the trouble ticket is resolved upon determining that the amount billed to the policy holder was correct and the policy holder was mistaken, upon release of the temporary hold, commencement of the delinquency proceedings may begin or the insurance business process may be configured to notify the policy holder of the resolution of the trouble ticket and release of the temporary hold such that without further action from the policy holder delinquency proceedings will commence.

Automatically providing 103 an opportunity to establish a temporary hold on the insurance business processes may include establishing a temporary hold during different stages of the insurance business process as shown in FIG. 4. By one approach, the end user may be provided 404 an opportunity to establish a temporary hold with respect to an insurance business process that is presently active. For example, if delinquency proceedings have already begun, the end user has the ability or the opportunity to establish a temporary hold on the delinquency proceeding such that the process does not advance further. By another approach, the end user may be provided 405 an opportunity to establish a temporary hold with respect to an insurance business process that has not yet become active or has not yet been initiated. For example, the end user can establish a temporary hold before the delinquency proceedings have commenced.

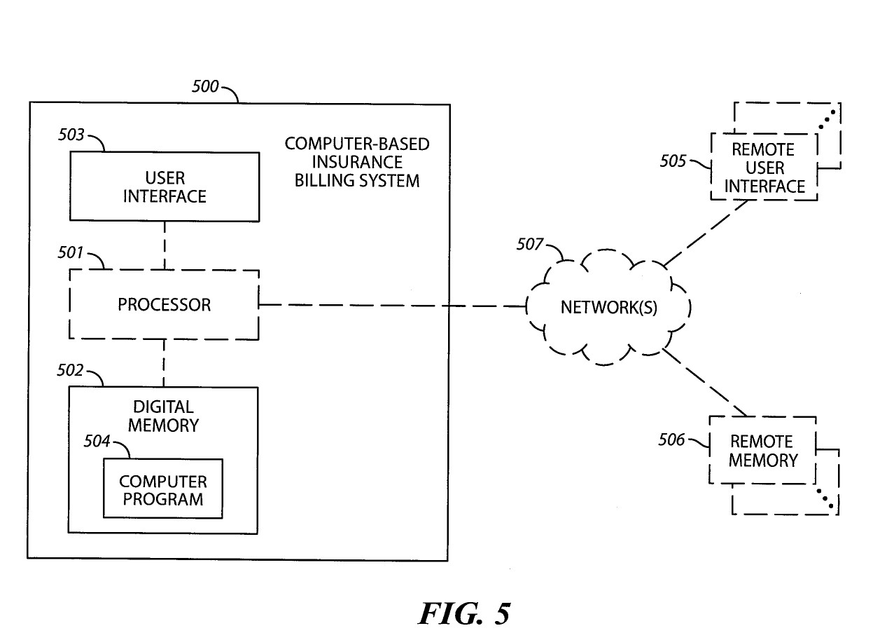

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 5, an illustrative approach to such a platform will now be provided.

FIG. 5 generally depicts pertinent portions of a computer-based insurance billing system 400 for facilitating or controlling an insurance business process. The computer-based insurance billing system 500 includes a processor 501 operably coupled to a digital memory 502 and a user interface 503. The user interface 503 as described herein includes a display as is typically used to convey and receive information. By one approach, the user interface 503 may comprise a browser-based interface, a user display, a user input such as a keyboard, and/or a cursor control interface of choice. It will be understood by those skilled in the art that a typical commercially viable offering will comprise a large number of user interfaces 503. As illustrated in FIG. 5, the processor 501 can also optionally couple to a remote user interface 505 and a remote memory 506 via a network 507.

Those skilled in the art will recognize and appreciate that such a processor 501 can comprise a fixed-purpose hard-wired platform or can comprise a partially or wholly programmable platform. All of these architectural options are well known and understood in the art and require no further description here.

The digital memory 502 has stored therein a computer program 504 wherein the computer program is configured and arranged for use in a computer-based insurance billing system that controls insurance business processes. The digital memory 502 also may store policy or account information. The digital memory 502 can comprise a single storage platform or can comprise a distributed memory. Such architectural choices are well understood in the art and require no additional elaboration here.

As mentioned, there are a number of insurance business processes that are stored in the digital memory 502 and those insurance business processes include delinquency proceedings, invoicing, accruing earned commissions, paying commissions, distributing received payments, and disbursing owed amounts, to note but a few. Due to a variety of circumstances such as disputed charges, lost payments, invoice errors, fraud suspicion, a disaster, and incorrect commission calculation, to note but a few, the ordinary insurance billing processes for an account or policy may require alteration from an automated norm. Based on the trouble ticket characteristics, the insurance billing system identifies which of the insurance business processes are affected and thus identifies the insurance business processes that may need to be temporarily stopped.

The computer program 504 is configured and arranged to provide 101 an opportunity to effect a trouble ticket with respect to the particular insurance entity via the user interface 503. Further, the computer program 504 is operably coupled to the processor 401 and automatically 102 determines the characteristics of the trouble ticket to identify related insurance business processes. The computer program 504 and the user interface 503 automatically provides 103 an opportunity to establish a temporary hold on those insurance processes that were identified as relating to the trouble ticket.

Those skilled in the art will recognize and understand that such a computer-based insurance billing system 500 may be comprised of a plurality of physically distinct elements. It is also possible, however, to view this illustration as comprising a logical view, in which case one or more of these elements can be enabled and realized via a shared platform. It will also be understood that such a shared platform may comprise a wholly or at least partially programmable platform as are known in the art.

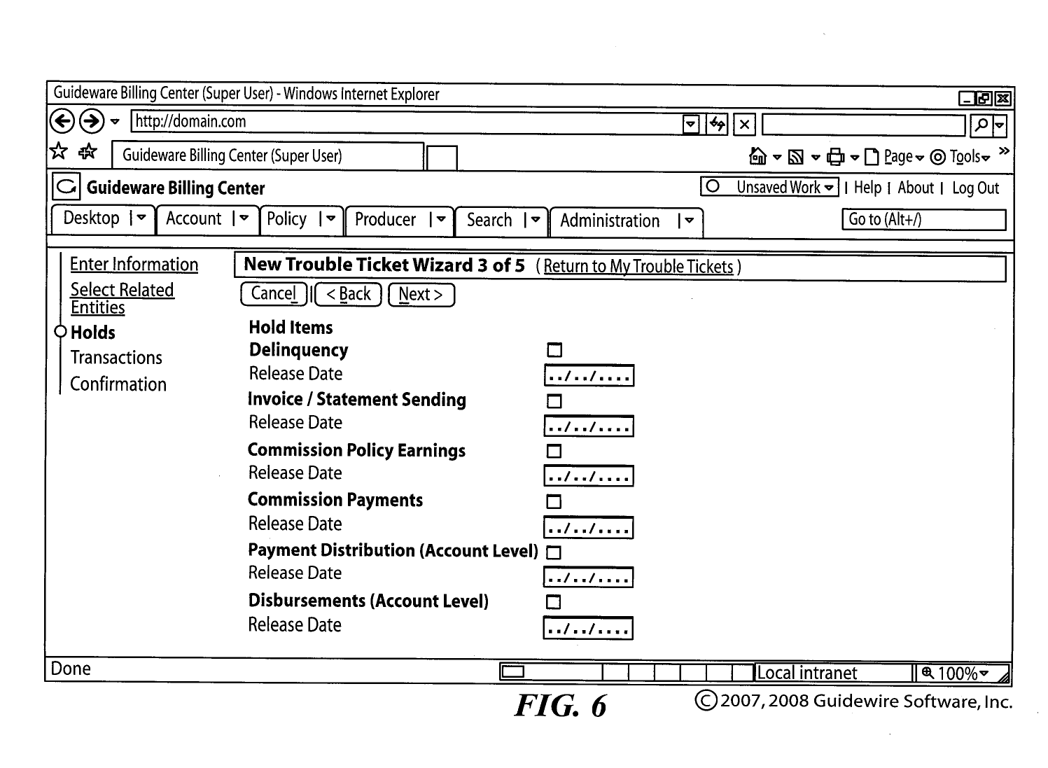

Turning now to FIG. 6, an illustrative screenshot of the user interface 403 shows an intermediate step in the creation of a trouble ticket, which in this example offers the end user the opportunity to select an insurance business process to temporarily hold by checking or selecting a box. FIG. 6 demonstrates a type of temporary hold that the end user may have an opportunity to establish as per the teachings set forth above. In this illustration, an end user is provided 401 with an opportunity to establish a hold that will automatically expire on a specified release date. Thus, when the release date is reached, the selected temporarily held insurance business processes will automatically resume the standard process. Other types of temporary holds include a hold that will expire upon the resolution of the trouble ticket or that will expire after a specified time period elapses.

In one illustrative example, the end user may potentially select multiple temporary holds for a given insurance entity. The temporary holds can be activated and deactivated as needed. If multiple temporary holds exist for a given entity, after the last temporary hold expires, is closed, or is otherwise resolved the standard insurance business processes will resume. In addition, multiple trouble tickets may exist for an insurance entity. If such multiple trouble tickets containing temporary holds exist for an insurance entity, then the insurance business processes held will continue or resume when the last of the trouble tickets containing the temporary holds is resolved.

In addition to selecting a plurality of insurance business processes to temporarily hold, under certain circumstances, it is anticipated that the end user may want to select a plurality of the insurance business processes. Further, if the selected insurance entity is a plurality of insurance entities the insurance business process or processes that were selected as temporarily held will be paused or temporarily stopped for each of the plurality of insurance entities.

These teachings, as set for above, provide for an efficient, economic, and effective approach to altering or adjusting the ordinary course of business to accommodate abnormal circumstances. In addition, these teachings add sufficient flexibility to the business processes such that they can be employed in a number of automated process in a variety of settings. As a result, the end users are able to more easily and advantageously manage their companies' business processes.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
in a computer-based insurance billing system that controls insurance business processes, wherein the insurance business processes comprise at least one of delinquency, invoicing, accruing earned commissions, paying commissions, distributing received payments, and disbursing owed amounts:
providing an opportunity via an end user interface to an end user to effect a trouble ticket with respect to a particular insurance entity;
in response to the end user acting upon the opportunity to effect a trouble ticket, automatically providing to the end user via the end user interface an opportunity to establish a temporary hold on the insurance business processes with respect to the particular insurance entity.

2. The method of claim 1 further comprising automatically determining characteristics of the trouble ticket to thereby identify which of the insurance business processes relate to the trouble ticket to thereby provide identified insurance business processes from which the end user may select the insurance business processes on which to establish the temporary hold.

3. The method of claim 1 further comprising, upon execution of one of the insurance business processes associated with a given insurance entity, determining whether a temporary hold is associated with respect to the insurance business process.

4. The method of claim 1 wherein the particular insurance entity may comprise a plurality of particular insurance entities and further comprising providing the end user an opportunity to manage the trouble ticket such that the insurance business processes selected to be temporarily held may apply to all or a portion of the plurality of particular insurance entities.

5. The method of claim 1 wherein providing an opportunity via an end user interface to an end user to effect a trouble ticket with respect to a particular insurance entity comprises, at least in part, providing an opportunity via the end user interface for the end user to specifically identify the particular insurance entity.

6. The method of claim 1 wherein providing an opportunity via an end user interface to an end user to effect a trouble ticket with respect to a particular insurance entity comprises, at least in part, providing an opportunity via the end user interface for the end user to identify the particular insurance entity via a relationship with another specified entity.

7. The method of claim 6 wherein the another specified entity comprises an entity having an insurance business process role with respect to the particular insurance entity.

8. The method of claim 1 wherein providing an opportunity via an end user interface to an end user to effect a trouble ticket with respect to a particular insurance entity comprises, at least in part, identifying the particular insurance entity by specifying a particular covered occurrence.

9. The method of claim 1 wherein providing an opportunity via an end user interface to an end user to effect a trouble ticket with respect to a particular insurance entity comprises, at least in part, identifying particular characterizing properties as correspond to the particular insurance entity.

10. The method of claim 1 wherein automatically providing to the end user via the end user interface an opportunity to establish a temporary hold on the identified insurance business processes with respect to the particular insurance entity comprises, at least in part, providing an opportunity to establish a temporary hold that will automatically expire on a specified date.

11. The method of claim 1 wherein automatically providing to the end user via the end user interface an opportunity to establish a temporary hold on the identified insurance business processes with respect to the particular insurance entity comprises, at least in part, providing an opportunity to establish a temporary hold that will automatically expire upon conclusion of a specified interval of time.

12. The method of claim 1 wherein automatically providing to the end user via the end user interface an opportunity to establish a temporary hold on the identified insurance business processes with respect to the particular insurance entity comprises, at least in part, providing an opportunity to establish a temporary hold that will automatically expire when the trouble ticket is resolved.

13. The method of claim 1 wherein automatically providing to the end user via the end user interface an opportunity to establish a temporary hold on the identified insurance business processes with respect to the particular insurance entity comprises, at least in part, providing an opportunity to establish a temporary hold with respect to an insurance business process that is presently active.

14. The method of claim 1 wherein automatically providing to the end user via the end user interface an opportunity to establish a temporary hold on the identified insurance business processes with respect to the particular insurance entity comprises, at least in part, providing an opportunity to establish a temporary hold with respect to an insurance business process that has not yet become active.

15. A digital memory having a computer program stored therein, wherein the computer program is configured and arranged for use in a computer-based insurance billing system that controls insurance business processes, wherein the insurance business processes comprise at least one of delinquency, invoicing, accruing earned commissions, paying commissions, distributing received payments, and disbursing owed amounts, the computer program being further arranged and configured to:
provide an opportunity via an end user interface to an end user to effect a trouble ticket with respect to a particular insurance entity;
automatically determine characteristics of the trouble ticket to thereby identify which of the insurance business processes relate to the trouble ticket to thereby provide identified insurance business processes;
automatically provide to the end user via the end user interface an opportunity to establish a temporary hold on the identified insurance business processes with respect to the particular insurance entity.

16. The digital memory of claim 15 wherein the computer program is further configured and arranged to provide an opportunity via an end user interface to an end user to effect a trouble ticket with respect to a particular insurance entity by, at least in part, providing an opportunity via the end user interface for the end user to specifically identify the particular insurance entity.

17. The digital memory of claim 15 wherein the computer program is further configured and arranged to provide an opportunity via an end user interface to an end user to effect a trouble ticket with respect to a particular insurance entity by, at least in part, providing an opportunity via the end user interface for the end user to identify the particular insurance entity via a relationship with another specified entity.

18. The digital memory of claim 15 wherein the computer program is further configured and arranged to provide an opportunity via an end user interface to an end user to effect a trouble ticket with respect to a particular insurance entity by, at least in part, identifying the particular insurance entity by specifying a particular covered occurrence.

19. The digital memory of claim 15 wherein the computer program is further configured and arranged to provide an opportunity via an end user interface to an end user to effect a trouble ticket with respect to a particular insurance entity by, at least in part, identifying particular characterizing properties as correspond to the particular insurance entity.

20. The digital memory of claim 15 wherein the computer program is further configured and arranged to automatically provide to the end user via the end user interface an opportunity to establish a temporary hold on the identified insurance business processes with respect to the particular insurance entity by, at least in part, providing an opportunity to establish a temporary hold that will automatically expire.

21. The digital memory of claim 15 wherein the computer program is further configured and arranged to automatically provide to the end user via the end user interface an opportunity to establish a temporary hold on the identified insurance business processes with respect to the particular insurance entity by, at least in part, providing an opportunity to establish a temporary hold with respect to an insurance business process that is presently active.

22. The digital memory of claim 15 wherein the computer program is further configured and arranged to automatically provide to the end user via the end user interface an opportunity to establish a temporary hold on the identified insurance business processes with respect to the particular insurance entity by, at least in part, providing an opportunity to establish a temporary hold with respect to an insurance business process that has not yet become active.
